(19) United States
(12) Patent Application Publication
(10) Pub. No.: US 2023/0419106 A1
(43) Pub. Date: Dec. 28, 2023

(54) Machine Learning Models Trained to Generate Household Predictions Using Energy Data

(71) Applicant: Oracle International Corporation, Redwood Shores, CA (US)

(72) Inventors: Selim MIMAROGLU, Arlington, VA (US); Anqi SHEN, McLean, VA (US); Oren BENJAMIN, Arlington, VA (US); Arhan GUNEL, Arlington, VA (US); Dmitriy FRADKIN, Wayne, PA (US); Ziran FENG, Austin, TX (US); Zheng YANG, Newton, MA (US)

(21) Appl. No.: 18/055,054

(22) Filed: Nov. 14, 2022

Related U.S. Application Data
(60) Provisional application No. 63/366,994, filed on Jun. 24, 2022.

(51) Int. Cl. G06N 3/08; G06Q 30/02

(52) U.S. Cl. CPC G06N 3/08; G06Q 30/0201

(57) ABSTRACT

Embodiments select households using machine learning predictions. One or more trained machine learning models can be stored. For example, at least one machine learning model can be trained to predict household income using time-series energy usage data. Input data including time-series energy usage data for a plurality of households can be received. Using the trained machine learning models, a household income is predicted per household. A subset of the households with a predicted household income that meets one or more campaign criteria can be selected. For example, the selected subset of the households can be targeted by an energy campaign that corresponds to the campaign criteria, and the energy campaign comprise one or more actions to alter energy usage for the targeted households.

### FIELD

The embodiments of the present disclosure generally relate to utility metering devices, and more particularly to generating household predictions using machine learning and utility metering devices.

### BACKGROUND

Household energy usage data has been analyzed for different purposes. For example, non-intrusive load monitoring (“NILM”) and disaggregation of various energy usage devices at a given source location has provided opportunities for improved energy infrastructure and/or energy usage patterns. NILM and disaggregation refers to taking as input total energy usage at a source location and estimating energy usage for one or more target devices that use energy at the source location. However, energy usage data can provide additional impactful signals about a household and its residents. Implementations that analyze household energy usage data to provide an improved understanding of a customer's household can improve overall energy infrastructure.

### BRIEF DESCRIPTION OF THE DRAWINGS

Further embodiments, details, advantages, and modifications will become apparent from the following detailed description of the preferred embodiments, which is to be taken in conjunction with the accompanying drawings.

FIG. 1 illustrates a system for selecting a subset of households using machine learning according to an example embodiment.

FIG. 2 illustrates a block diagram of a computing device operatively coupled to a system according to an example embodiment.

FIG. 3 illustrates a diagram for using machine learning model(s) to select a subset of households according to an example embodiment.

FIG. 4A illustrates an example convolutional neural network according to embodiments.

FIG. 4B illustrates an example convolutional neural network with example blocks according to example embodiments.

FIG. 5 illustrates a flow diagram for selecting a subset of households using machine learning according to an example embodiment.

### DETAILED DESCRIPTION

Embodiments relate to machine learning model(s) trained to process energy usage data and generate household predictions. Machine learning model(s) can be trained to predict household data values for energy usage profiles, and these household data values can then be used to target a subset of the energy usage profiles. For example, a customer energy usage profile can be associated with a household (at which energy is consumed). In some embodiments, at least one machine learning model can be configured (e.g., trained) to predict a household income using time-series household energy usage data (e.g., metered electricity usage). In another example, at least one machine learning model can be configured to predict a number of people at a household using time-series household energy usage data. In another example, at least one machine learning model can be configured to predict an age category for people at a household using time-series household energy usage data. For example, two categories can be predefined, where the detection of a household member that is an age above a threshold (e.g., 60, 65, 68, 70, and the like) places a household in a first of the two categories, and the lack of such a household member places the household in a second of the two categories.

In another example, at least one machine learning model can be configured to predict, using time-series household energy usage data of a first type (e.g., electricity energy usage), a second type of energy usage for the household (e.g., gas energy usage). Implementations of these machine learning models can use time-series energy usage data (e.g., electricity usage) at any suitable granularity (e.g., 30 seconds, 1 minute, 5 minutes, 15 minutes, 30 minutes, hourly, daily, weekly, monthly, and the like), weather information, one or more static pieces of household information (e.g., household real-estate value, census tract income range, demographic information, home features, and the like), and any other suitable information.

In some embodiments, the one or more machine learning models can be configured to predict income, number of people, age categories, and/or second type of energy usage (e.g., gas usage) over a region (rather than per household) using time-series energy usage data of the first type for households across the region. For example, given a geographic region (e.g., census tract, city, county, state, or any other suitable shape for a geographic region), the machine learning model(s) can predict incomes over the geographic region (e.g., average income per household, aggregate income across households, and the like), number of people over the geographic region (e.g., average number of people per household, aggregate number of people living in the region, and the like), age categories for people that reside within the geographic region (e.g., average or aggregate number of people within predefined age ranges), and/or second type of energy usage of the geographic region (e.g., average gas usage per household, aggregate gas usage per household, etc.).

Embodiments train machine learning model(s) using instances of time-series energy usage data of the first type (e.g., metered electricity usage) and labels (e.g., household income labels, number of people labels, age for number of people criteria, gas usage labels, and the like). For example, a machine learning model can be designed/selected, such as a neural network. Energy usage data of the first type from multiple source locations (e.g., households) can be obtained, where the energy usage data of the first type can be labeled with income values, number of people in the household values, household resident age values, energy usage values of the second type (e.g., gas usage labels), and/or other suitable label data. In some embodiments, this household energy usage data and label data can be processed to generate training data for the machine learning model(s).

Some embodiments implement an architecture on a deep learning framework. Implementations of the architecture are also extensible and can be tailored with respect to the size of the input and output. The functionality of the deep learning framework, such as initialization of the layers, the implemented optimizer, regularization of values, dropout, and the like can be utilized, removed, or adjusted.

Some embodiments include a convolutional neural network (CNN). In practice, many applications of CNNs are designed to recognize visual patterns (e.g., directly from images for classification). On the other hand, embodiments use a CNN architecture for predicting household information using time-series household energy usage data of the first type (e.g., metered electricity usage). For example, the CNN can be designed to have a number of convolutional layers with various kernel sizes and shapes. This design can be used to learn trends and other aspects of the metered energy usage data. In some embodiments, the deep learning framework includes multiple architectures, such as a recurrent neural network (RNN), convolutional neural network (CNN), one or more blocks of known neural networks (e.g., LeNet, AlexNet, ZFNet, GoogleNet/Inception, VGGNet, ResNet, etc.). Any other suitable neural network architecture or machine learning architecture can be implemented.

In some embodiments, the machine learning model(s) can be configured to generate income prediction(s), number of people prediction(s), age category prediction(s), and/or second type of energy usage prediction(s) using time-series energy usage data of the first type for a plurality of households over a defined period of time, such as weeks, a month, multiple months, a quarter, a year, multiple years, and the like. For example, the time-series data input to generate the prediction(s) can be processed such that it covers the defined period of time. Other input data (e.g., weather data) can be similarly processed to cover the period of time. In some implementations, the period of time can be adjusted, for example during training, testing, retraining, and/or tuning, to achieve a desired performance for the machine learning model(s).

Some embodiments utilize multiple trained learning models, such as an ensemble approach that combines outputs from multiple trained models. Embodiments that implement the ensemble approach can train or configure individual machine learning models for specific prediction tasks, such as predicting household income, predicting a number of people for a household, predicting an age category for people at the household, and/or predicting second type of energy usage values for the household.

In some implementations, the multiple trained models of the ensemble approach operate in parallel (rather than in sequence). For example, two, three, or more individual machine learning models can receive, as input, the first type of energy usage (e.g., metered electricity usage) for a given household along with other suitable features for the given household and each can generate an individual component prediction (e.g., income prediction, number of people prediction, age category prediction, or second type of energy usage prediction). In some implementations, the other features for the given household received by each individual model can comprise similar features, different features, or any other suitable set of other household features. For example, each individual model can receive a set of other household features, where some features are shared among the sets and some features are only provided to one or more of the individual models. One or more of the model predictions can be used to select a subset of households/customer profiles that meet a campaign qualification.

In some implementations, the campaign qualification can relate to one or more campaigns that reduce the energy burden on qualifying households. The qualification for such campaigns can include meeting income criteria based on a number of people at a given household. In some examples, the age of the people at a given household can also impact qualification for a campaign. Different campaigns can reduce energy burden in different ways, such as through cost saving incentives, supporting device upgrades (e.g., credits for upgrading heating and cooling systems, household appliances, household insulation, and other devices), providing credits for low-income households, credits for insulation repairs/upgrades, and the like. Implementations of these campaigns can improve the overall performance of an energy grid, such as by achieving improved efficiencies for energy consuming devices that consume energy from the power grid, increasing the efficiency of heating or cooling a household via improved insulation, or through other suitable improvements.

Reference will now be made in detail to the embodiments of the present disclosure, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

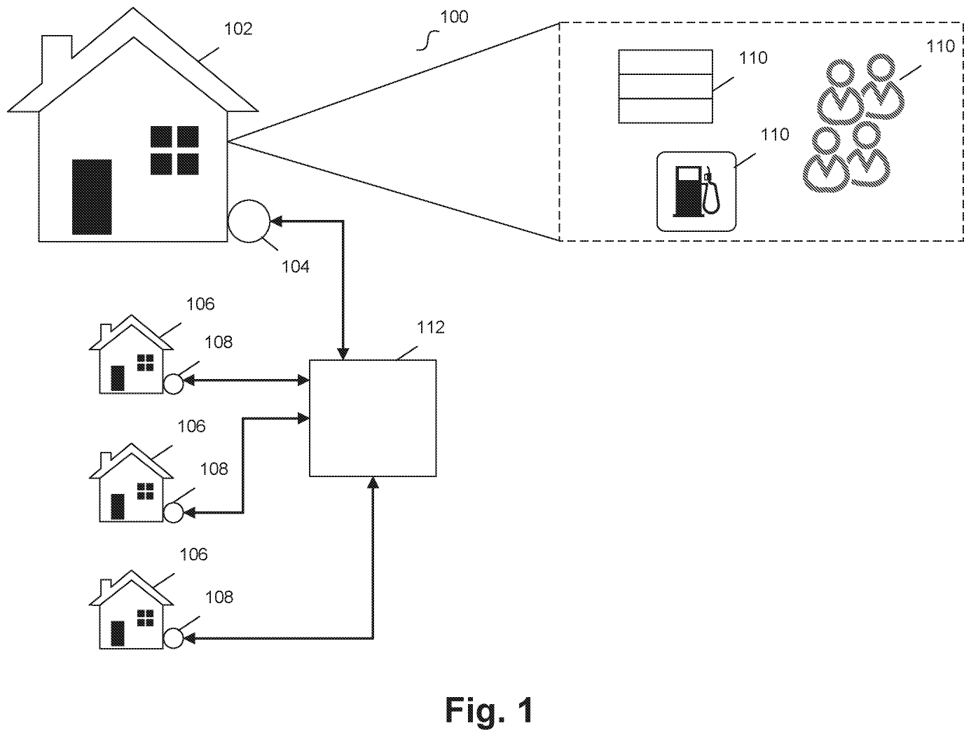

FIG. 1 illustrates a system for selecting a subset of households using machine learning according to an example embodiment. System 100 includes source location 102, meter 104, source locations 106, meters 108, household information 110, and network node 112. Source location 102 can be any suitable location that includes or is otherwise associated with devices that consume or produce energy, such as a household. In some embodiments, energy consuming devices at source location 102 can include electrical appliances and/or electrical vehicles that use energy, such as a washer, dryer, air conditioner, heater, refrigerator, television, computing device, and the like. For example, source location 102 can be supplied with power (e.g., electricity), and the energy consuming devices can draw from the power supplied to source location 102. In some embodiments, source location 102 is a household and the power to the household is supplied from an electric power grid, a local power source (e.g., solar panels), a combination of these, or any other suitable source.

In some embodiments, meter 104 can be used to monitor the energy usage (e.g., electricity usage) at source location 102. For example, meter 104 can be a smart meter, an advanced metering infrastructure (“AMI”) meter, an automatic meter reading (“AMR”) meter, a simple energy usage meter, and the like. In some embodiments, meter 104 can transmit information about the energy usage at source location 102 to a central power system, a supplier, a third party, or any other suitable entity. For example, meter 104 can implement two-way communication with an entity in order to communicate the energy usage at source location 102. In some embodiments, meter 104 may implement one-way communication with an entity, where meter readings are transmitted to the entity.

In some embodiments, meter 104 can communicate over wired communication links and/or wireless communication links, and can leverage wireless communication protocols (e.g., cellular technology), Wi-Fi, wireless ad hoc networks over Wi-Fi, wireless mesh networks, low power long range wireless (“LoRa”), ZigBee, Wi-SUN, wireless local area networks, wired local area networks, Home Area Network (HAN), including IEEE 2030.5, and the like. Energy consuming devices can use energy at source location 102, and meter 104 can monitor the energy usage for the source location and report the corresponding data (e.g., to network node 112).

In some embodiments, household information 110 can include information about source location 102, such as a household income (e.g., aggregate of the income earned by members of the household), number of people in the household (e.g., number of people that reside in the household), age category for the people within the household (e.g., whether people in the household or above a defined age, such as 60, 65, 70, and the like), predicted energy usage of a second type (e.g., gas energy usage), or any other suitable household information. Embodiments analyze the energy usage at source location 102 (e.g., metered by meter 104) to predict household information 110 using machine learning model(s).

In some embodiments, source locations 106 and meters 108 can be similar to source location 102 and meter 104. For example, networking node 112 can receive energy usage information about source location 102 and source locations 106 from meter 104 and meters 106. In some embodiments, network node 112 can be part of a central power system, a supplier, a power grid, an analytics service provider, a third-party entity, or any other suitable entity.

The following description includes recitations of a criterion or criteria. These terms are used interchangeably throughout the disclosure, the scope of criteria is intended to include the scope of criterion, and the scope of criterion is intended to include the scope of criteria.

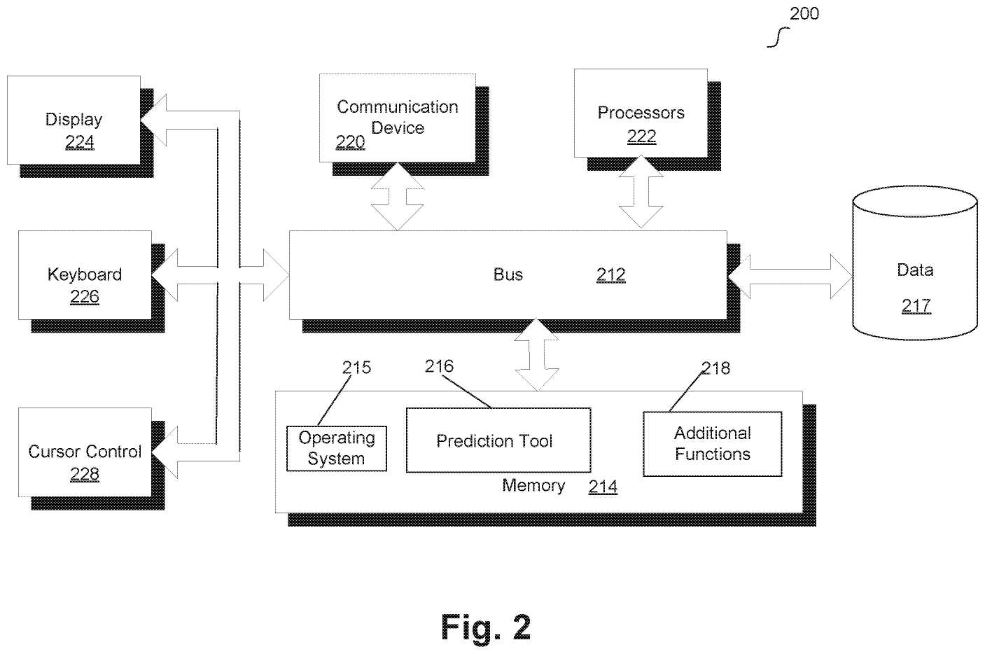

FIG. 2 is a block diagram of a computer server/system 200 in accordance with embodiments. All or portions of system 200 may be used to implement any of the elements shown in FIG. 1. As shown in FIG. 2, system 200 may include a bus device 212 and/or other communication mechanism(s) configured to communicate information between the various components of system 200, such as processor 222 and memory 214. In addition, communication device 220 may enable connectivity between processor 222 and other devices by encoding data to be sent from processor 222 to another device over a network (not shown) and decoding data received from another system over the network for processor 222.

For example, communication device 220 may include a network interface card that is configured to provide wireless network communications. A variety of wireless communication techniques may be used including infrared, radio, Bluetooth®, Wi-Fi, and/or cellular communications. Alternatively, communication device 220 may be configured to provide wired network connection(s), such as an Ethernet connection.

Processor 222 may include one or more general or specific purpose processors to perform computation and control functions of system 200. Processor 222 may include a single integrated circuit, such as a micro-processing device, or may include multiple integrated circuit devices and/or circuit boards working in cooperation to accomplish the functions of processor 222. In addition, processor 222 may execute computer programs, such as operating system 215, prediction tool 216, and other applications 218, stored within memory 214.

System 200 may include memory 214 for storing information and instructions for execution by processor 222. Memory 214 may contain various components for retrieving, presenting, modifying, and storing data. For example, memory 214 may store software modules that provide functionality when executed by processor 222. The modules may include an operating system 215 that provides operating system functionality for system 200. The modules can include an operating system 215, a prediction tool 216 that implements the household prediction functionality disclosed herein, as well as other applications modules 218. Operating system 215 provides operating system functionality for system 200. In some instances, prediction tool 216 may be implemented as an in-memory configuration. In some implementations, when system 200 executes the functionality of prediction tool 216, it implements a non-conventional specialized computer system that performs the functionality disclosed herein.

Non-transitory memory 214 may include a variety of computer-readable medium that may be accessed by processor 222. For example, memory 214 may include any combination of random access memory (“RAM”), dynamic RAM (“DRAM”), static RAM (“SRAM”), read only memory (“ROM”), flash memory, cache memory, and/or any other type of non-transitory computer-readable medium. Processor 222 is further coupled via bus 212 to a display 224, such as a Liquid Crystal Display (“LCD”). A keyboard 226 and a cursor control device 228, such as a computer mouse, are further coupled to communication device 212 to enable a user to interface with system 200.

In some embodiments, system 200 can be part of a larger system. Therefore, system 200 can include one or more additional functional modules 218 to include the additional functionality. Other applications modules 218 may include various modules of Oracle® Utilities Customer Cloud Service, Oracle® Cloud Infrastructure, Oracle® Cloud Platform, Oracle® Cloud Applications, for example. Prediction tool 216, other applications module 218, and any other suitable component of system 200 can include various modules of Oracle® Data Science Cloud Service, Oracle® Data Integration Service, or other suitable Oracle® products or services.

A database 217 is coupled to bus 212 to provide centralized storage for modules 216 and 218 and to store, for example, data received by prediction tool 216 or other data sources. Database 217 can store data in an integrated collection of logically related records or files. Database 217 can be an operational database, an analytical database, a data warehouse, a distributed database, an end-user database, an external database, a navigational database, an in-memory database, a document-oriented database, a real-time database, a relational database, an object-oriented database, a non-relational database, a NoSQL database, Hadoop® distributed file system (“HFDS”), or any other database known in the art.

Although shown as a single system, the functionality of system 200 may be implemented as a distributed system. For example, memory 214 and processor 222 may be distributed across multiple different computers that collectively represent system 200. In one embodiment, system 200 may be part of a device (e.g., smartphone, tablet, computer, etc.). In an embodiment, system 200 may be separate from the device, and may remotely provide the disclosed functionality for the device. Further, one or more components of system 200 may not be included. For example, for functionality as a user or consumer device, system 200 may be a smartphone or other wireless device that includes a processor, memory, and a display, does not include one or more of the other components shown in FIG. 2, and includes additional components not shown in FIG. 2, such as an antenna, transceiver, or any other suitable wireless device component.

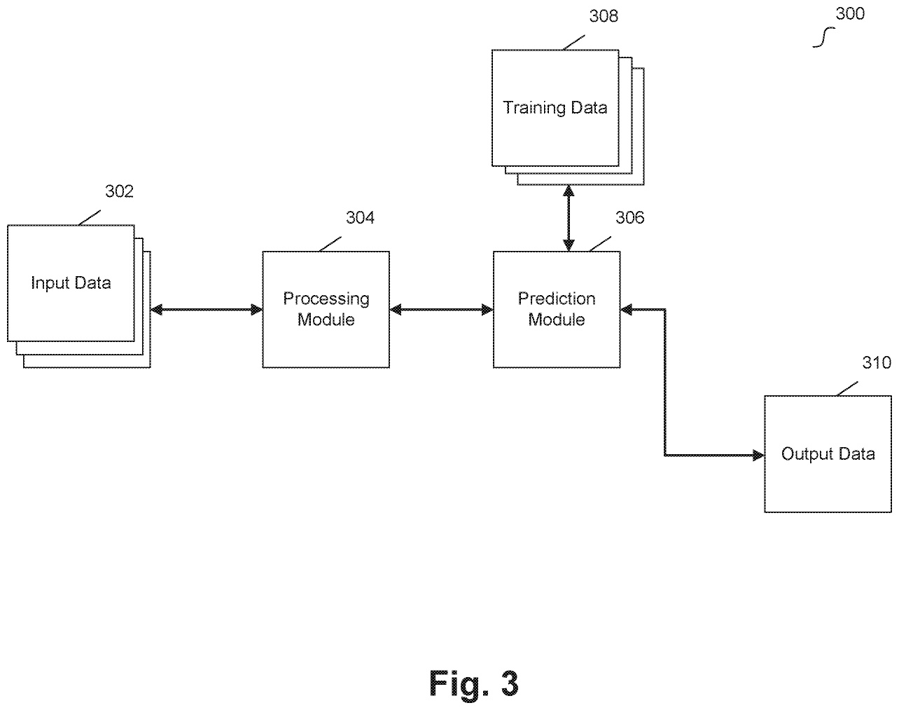

FIG. 3 illustrates a diagram for using machine learning model(s) to target energy usage customers according to an example embodiment. System 300 includes input data 302, processing module 304, prediction module 306, training data 308, and output data 310. In some embodiments, input data 302 can include a first type of energy usage from a household (e.g., electricity usage), and the data can be processed by processing module 304. For example, processing module 304 can process input data 302 to generate features based on the input data.

In some embodiments, prediction module 306 can be one or more machine learning modules (e.g., neural network) that are trained by training data 308. For example, training data 308 can include labeled data, such as household income information (e.g., for source locations 102 and 106 from FIG. 1), number of people at a household, age category for the people at the household, second type of energy usage for the household (e.g., gas usage), and the like. In some embodiments, the output from processing module 304, such as the processed input, can be fed as input to prediction module 306. Prediction model 306 can generate output data 310, such as predicted household income information, predicted number of people at the household, predicted age category for people at the household, and/or predicted second type of energy usage for the household. In some embodiments, input data 302 can be source location energy usage data (e.g., metered electricity usage) and output data 310 can be one or more pieces of predicted household information.

Embodiments use machine learning models, such as neural networks, to predict household information. Neural networks can include multiple nodes called neurons that are connected to other neurons via links or synapses. Some implementations of neural networks can be aimed at classification tasks and/or can be trained under supervised learning techniques. In many cases, labeled data can include features that help in achieving a prediction task (e.g., household information predictions). In some embodiments, neurons in a trained neural network can perform a small mathematical operation on given input data, where their corresponding weights (or relevance) can be used to produce an operand (e.g., produced in part by applying a non-linearity) to be passed further into the network or given as the output. A synapse can connect two neurons with a corresponding weight/relevance. Prediction model 306 from FIG. 3 can be one or more neural networks.

In some embodiments, a neural network can be used to learn trends within labeled energy usage data values. For example, training data 308 can include features and these features can be used by a neural network (or other learning model) to identify trends and predict household information from overall household energy usage. In some embodiments, once a model is trained/ready it can be deployed. Embodiments can be implemented with a number of products or services (e.g., Oracle® products or services).

In some embodiments, the design of prediction module 306 can include any suitable machine learning model components (e.g., a neural network, support vector machine, specialized regression model, and the like). For example, a neural network can be implemented along with a given cost function (e.g., for training/gradient calculation). The neural network can include any number of hidden layers (e.g., 0, 1, 2, 3, or many more), and can include feed forward neural networks, recurrent neural networks, convolution neural networks, modular neural networks, and any other suitable type.

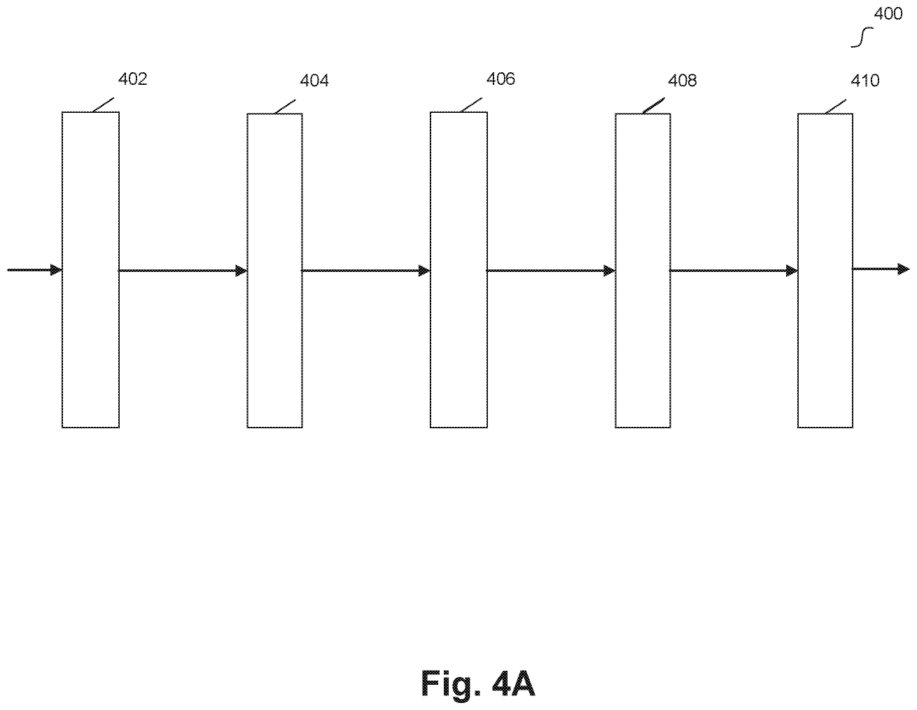

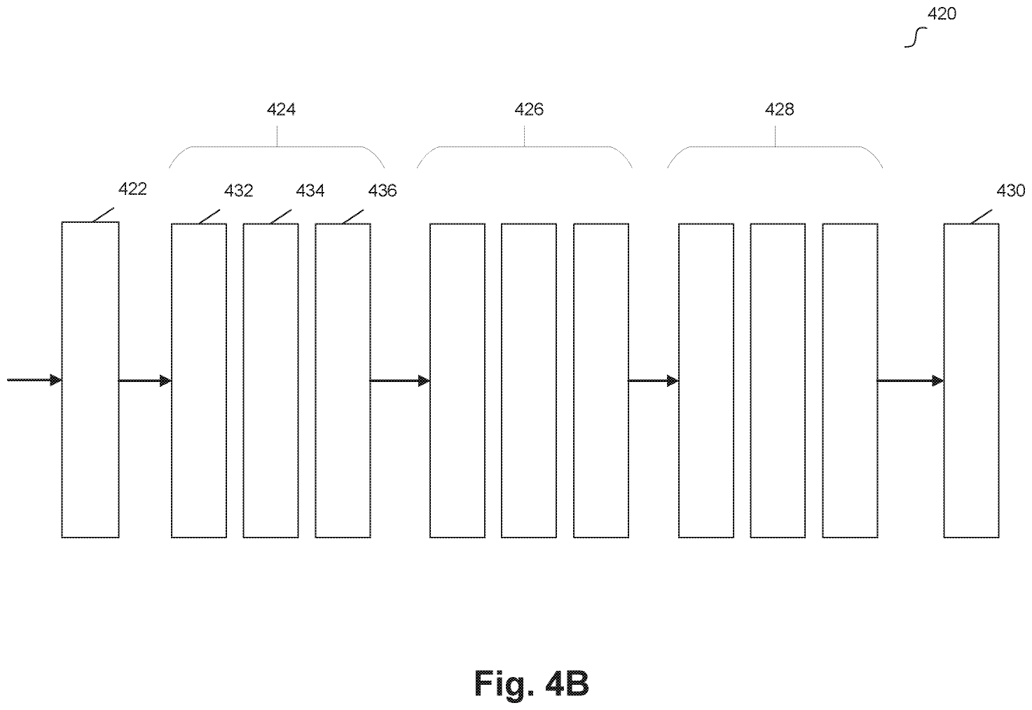

FIG. 4A illustrates an example convolutional neural network according to embodiments. CNN 400 of FIG. 4A includes components 402, 404, 406, 408, and 410. In some embodiments, one or more components 402, 404, 406, 408, and 410 can be convolutional layers. For example, at a given layer of a convolutional neural network, one or more filters or kernels can be applied to the input data of the layer. For example, components 402, 404, and 406 can be convolutional layers that each apply a filter or kernel. The shape of the data and the underlying data values can be changed from input to output depending on the shape of the applied filter or kernel (e.g., 1×1, 1×2, 2×1, 2×2, 3×1, 1×3, 2×3, 3×2, 3×3, and the like), the manner in which the filter or kernel is applied (e.g., mathematical application), and other parameters (e.g., stride). In embodiments, the kernels applied at components 402, 404, and 406 can have one consistent shape among them, two different shapes, or three different shapes (e.g., all the kernels are different sizes).

In some instances, the layers of a convolutional neural network can be heterogeneous and can include different mixes/sequences of convolution layers, pooling layers, fully connected layers (e.g., akin to applying a 1×1 filter), and the like. For example, layers 408 and 410 can be fully connected layers. In this example, CNN 400 illustrates an embodiment of a feed forward convolutional neural network with a number of convolution layers (e.g., implementing filters or kernels) followed by fully connected layers. Embodiments can implement any other suitable convolutional neural networks.

For example, one or more components 402, 404, and 406 can be parallel convolutional layers followed by a concatenating layer, such as component 408. In some embodiments, the concatenated output from component 408 can be fed into component 410, which can be a fully connected layer. In some embodiments, components 402, 404, 406, and 408 in a parallel architecture (e.g., three parallel convolutional layers and a concatenation layer) can represent a block within CNN 400, and one or more additional blocks can be implemented before or after the depicted block. An example block includes at least two parallel convolutional layers followed by a concatenation layer. In some embodiments, a number of additional convolutional layers (e.g., more than two) with various parallel structures can be implemented as a block.

In some embodiments, one or more of components 402, 404 406, 408, and 410 can represent blocks of a CNN architecture, a recurrent neural network (RNN) architecture, a mixed neural network architecture, or any other suitable neural network component. For example, networks such as one or more of LeNet, AlexNet, ZFNet, GoogleNet/Inception, VGGNet, ResNet, ResNet with squeeze and excitation, or any other suitable neural network architecture can be implemented. In some embodiments, the neural network can be configured for deep learning, for example based on the number of hidden layers implemented.

FIG. 4B illustrates an example convolutional neural network with example blocks according to embodiments. CNN 420 of FIG. 4B includes input layer 422, blocks 424, 426, and 428, and output layer 430. Input layer 422 can by any suitable layer that takes input data in any suitable shape. Blocks 424, 426, and 428 can be any suitable machine learning component blocks, such as ResNet blocks. For example, block 424 comprises layers 432, 434, and 436, which can be convolutional layers that implement any suitable filter size(s). Layers 432, 434, and 436 can be feed forward convolutional layers. In some embodiments, connections among layers 432, 434, and 436 can include skip connections (e.g., identity connections). In some embodiments, blocks 426 and 428 can be similar in structure to block 432. CNN 420 can include one or more pooling layers (e.g., max pool, max pool/2, average pool, average pool/2, and the like) and/or fully connected layers, such as between input layer 422 and block 424, between any of blocks 424, 426, and 428, between block 428 and output layer 430, or at any other suitable location in the architecture. In some embodiments, CNN 420 can include one or more squeeze and excitation blocks. For example, squeeze and excitation blocks can include a combination of pooling layer(s), fully connected layer(s), activation function layer(s) (e.g., sigmoid, ReLU, etc.), and any other suitable layer. Squeeze and excitation layers can improve channel interdependence for implementations of CNN 420.

Returning to FIG. 3, prediction module 306 can include any other suitable machine learning models or components. In some examples, a Bayesian network can be similarly implemented, or other types of supervised learning models. For example, a support vector machine can be implemented, in some instances along with one or more kernels (e.g., gaussian kernel, linear kernel, and the like). In some embodiments, prediction module 306 of FIG. 3 can be multiple models stacked, for example with the output of a first model feeding into the input of a second model, with the output of multiple models being combined, or in any other suitable manner. Some implementations can include a number of layers of prediction models.

In some embodiments, testing instances can be given to the model to calculate its accuracy. For example, a portion of training data 308/labeled energy usage data can be reserved for testing the trained model (e.g., rather than training the model). The accuracy measurement can be used to tune prediction module 306. In some embodiments, accuracy assessment can be based on a subset of the training data/processed data. For example, a subset of the data can be used to assess the accuracy of a trained model (e.g., a 70%, 15%, and 15% ratio for training, validation, and testing, and the like). In some embodiments, the data can be randomly selected for the testing and training segments over various iterations of the testing.

In some embodiments, when testing, a trained model can output a predicted data value for household information of a given household based on input for the given household (e.g., instance of testing data). Because the household information is known for the given input/testing instance, the predicted value can be compared to the known value to generate an accuracy metric. Based on testing the trained model using multiple instances of testing data, an accuracy for the trained model can be assessed.

In some embodiments, the design of prediction module 306 can be tuned based on accuracy calculations during training, retraining, and/or updated training. For example, tuning can include adjusting a number of hidden layers in a neural network, adjusting a kernel calculation (e.g., used to implement a support vector machine or neural network), and the like. This tuning can also include adjusting/selecting features used by the machine learning model, adjustments to the processing of input data, and the like. Embodiments include implementing various tuning configurations (e.g., different versions of the machine learning model and features) while training/calculating accuracy in order to arrive at a configuration for prediction module 306 that, when trained, achieves desired performance (e.g., performs predictions at a desired level of accuracy, runs according to desired resource utilization/time metrics, and the like). In some embodiments, trained model(s) can be saved or stored for further use and for preserving its state. For example, the training of prediction module 306 can be performed “off-line” and the trained model(s) can then be stored and used as needed to achieve time and resource efficient data prediction.

Embodiments of prediction module 306 are trained to predict household information for energy usage profiles, and this household information can then be used to select a subset of the energy usage profiles/households. For example, a profile can correspond to customer of an energy utility/provider (e.g., household), where the predicted household information can include a predicted household income (or a predicted household income category that corresponds to an income range), predicted number of people at the household (or a predicted household number of people category that corresponds to a range of the number of people), a predicted age category for the people at the household (e.g., a predicted age category that corresponds to an age range for the people at the household), and/or a predicted second type of energy usage (e.g., gas usage at any suitable granularity).

In some embodiments, prediction module 306 can be two, three, four, or more individual prediction models. For example, prediction module 306 can include at least one machine learning model configured (e.g., trained) to predict a household income using time-series household energy usage data of a first type (e.g., electricity usage). Embodiments train prediction module 306 using instances of time-series energy usage data and household income labels. For example, energy usage data from multiple source locations (e.g., households) can be obtained, where the energy usage data can be labeled with household income values that corresponds to the households. In some embodiments, this household energy usage data and household income label data can be processed to generate training data 308 for prediction module 306. Training data 308 can train prediction module 306 to predict household income from household energy usage data for a new household.

In some embodiments, the predicted household income can be a prediction of an income range (e.g., $0-$15,000, $15,001-$30,000, $30,001-$45,000, $45,001-$60,000, $60,001-$75,000, $75,001-$100,000, $100,001-$115,000, and so on). For example, the output can be an array with confidence values that the new household comprises the income range that corresponds to the array element. Implementations can adjust these income ranges, for example during training, testing, retraining, and/or tuning, to achieve desired levels of machine learning model precision, recall, a balance of these values, or any other suitable performance metrics.

In another example, prediction module 306 can include at least one machine learning model configured to predict a number of people at a household using time-series household energy usage data of a first type (e.g., electricity usage). Embodiments train prediction module 306 using instances of time-series energy usage data and number of people at a household labels. For example, energy usage data from multiple source locations (e.g., households) can be obtained, where the energy usage data can be labeled with number of people values that corresponds to the households (e.g., number of people that reside in the household). In some embodiments, this household energy usage data and number of people label data can be processed to generate training data 308 for prediction module 306. Training data 308 can train prediction module 306 to predict a number of people for a new household from household energy usage data for the new household.

In some embodiments, the predicted number of people can be a prediction of a range for the number of people (e.g., 0-2, 3-5, 6-8, and so on, or 0-1, 1-2, 2-3, 3-4, 4-5-6, 6-7, 7-8, and so on). For example, the output can be an array with confidence values that the new household falls into the number of people range that corresponds to the array element. Implementations can adjust these number of people ranges, for example during training, testing, retraining, and/or tuning, to achieve desired levels of machine learning model precision, recall, a balance of these values, or any other suitable performance metrics.

In another example, prediction module 306 can include at least one machine learning model configured to predict an age category for people at a household using time-series household energy usage data of a first type (e.g., electricity usage). Embodiments train prediction module 306 using instances of time-series energy usage data and age labels for household people. For example, energy usage data from multiple source locations (e.g., households) can be obtained, where the energy usage data can be labeled with age labels for people within the household. In some embodiments, this household energy usage data and age label data can be processed to generate training data 308 for prediction module 306. Training data 308 can train prediction module 306 to predict an age category for people within a new household from household energy usage data for the new household.

In some embodiments, the predicted age category can be a prediction of age range(s) for the people living in the new household (e.g., ages 0-10, ages 11-20, ages 21-30, ages 31-40, ages 41-50, ages 51-60, ages 61-70, ages 71-80, ages 81-90, ages 90 and above). For example, the output can be an array with confidence values that a person living within the household comprises the age range that corresponds to the array element. Implementations can adjust these age ranges, for example during training, testing, retraining, and/or tuning, to achieve desired levels of machine learning model precision, recall, a balance of these values, or any other suitable performance metrics.

In another example, prediction module 306 can include at least one machine learning model configured to predict household energy usage of a second type (e.g., gas usage) using time-series household energy usage data of a first type (e.g., electricity usage). Embodiments train prediction module 306 using instances of time-series energy usage data of the first type and second type of energy usage labels. For example, electricity energy usage data from multiple source locations (e.g., households) can be obtained, where the electricity energy usage data is labeled with gas energy usage. In some embodiments, this household energy usage data of the first type and second type of energy usage label data can be processed to generate training data 308 for prediction module 306. Training data 308 can train prediction module 306 to predict second type of energy usage for a new household from household energy usage data of the first type for the new household.

In some embodiments, the predicted second type of energy usage can be predictions for energy usage of the second type by the corresponding household(s) of a predetermined time granularity (e.g., 30 seconds, 1 minute, 5 minutes, 15 minutes, 30 minutes, hourly, daily, weekly, monthly, and the like) over a predetermined period of time (e.g., period of time that matches the input data/electricity energy usage data, weeks, 1 month, 3 months, 6 months, 1 year, years, and the like). Implementations can adjust these time values, for example during training, testing, retraining, and/or tuning, to achieve desired levels of machine learning model precision, recall, a balance of these values, or any other suitable performance metrics. In some implementations, the functionality of one, two, three, or more of these machine learning models can be implemented by a single machine learning model.

Implementations of prediction module 306 can use time-series energy usage data at any suitable granularity (e.g., second(s), hour(s), day(s), week(s), month(s), and the like) and one or more static pieces of household data (e.g., household real-estate value, census tract income range, and the like). For example, one or more of the neural networks implemented by prediction module 306 can comprise an input layer that receives time-series energy usage data for a household and static household data. In this example, the neural network(s) can be configured/trained to generate household information prediction(s) (e.g., predicated household income, predicted number of people, predicted age category, and/or predicted second type of energy usage) according to the time-series energy usage data and static household data.

Implementations of the neural network(s) can process the time-series energy usage data of the first type (e.g., electricity usage) and the static household data using different flows to generate data predictions. For example, a path can represent the flow input data takes through the neural network architecture, such as the links connecting neural network components traversed from the input layer to the output layer. The time-series data can be processed on a first path through the neural network (e.g., via neural network layers/blocks followed by fully connected layers, or through any other suitable flow) while the static household data can be processed on a second path through the neural network (e.g., directly input to fully connected layers, or through any other suitable flow that is different from the first path) to generate the data prediction(s). In some implementations, portions of the first path can be parallel to portions of the second path. For example, some or all of the neural network links traversed by the time-series energy usage data via the first path can be parallel to some or all of the neural network links traversed by the static household data via the second path. In some implementations, the input layer for the machine learning model(s) can also receive weather information for a household, and the neural network can be configured/trained to predict the household information according to the time-series energy usage data for the household, weather data for the household, and static household data. Example weather information includes temperature values, dew point values, pressure values, or any other suitable weather information.

In some implementations, multiple trained individual models of prediction module 306 can operate in parallel (rather than in sequence). For example, two, three, or more individual machine learning models can receive, as input, the first type of energy usage (e.g., metered electricity usage) for a given household along with other suitable features for the given household and each can generate an individual component prediction (e.g., income prediction, number of people prediction, age category prediction, or second type of energy usage prediction). In some implementations, the other features (e.g., static pieces of household data, weather data, and the like) for the given household received by each individual model can comprise similar features, different features, or any other suitable set of other household features. For example, each individual model can receive a set of other household features, where some features are shared among the sets and some features are only provided to one or more of the individual models.

In some embodiments, the one or more machine learning models can be configured/trained to predict income, number of people, age category, and/or second type of energy usage (e.g., gas usage) over a region (rather than per household) using time-series energy usage data of the first type for households across the region. For example, over a given geographic region (e.g., census tract, city, county, state, or any other suitable shape for a geographic region), the machine learning model(s) can predict incomes over the geographic region (e.g., average income per household, aggregate income across households, and the like), number of people over the geographic region (e.g., average number of people per household, aggregate number of people living in the region, and the like), age categories for the people over the geographic region (e.g., average or aggregate number of people within predefined age ranges), and/or second type of energy usage over the geographic region (e.g., average second type of energy usage per household, aggregate second type of energy usage across households, and the like).

In some implementations, the predicted household information can be used to target customer profiles (e.g., energy utility customers). For example, a customer profile can be associated with a given household, and one or more machine learning models can be trained/configured to predict household information for the given household. In some implementations, the predicted household income and predicted number of people for the given household can be compared to one or more qualification criteria for a campaign. An example qualification criteria based on household income and household size is defined in the below table:

| | Maximum Monthly Household |
|---|---|
| Household Size | Income Standards |
| 1 | $2,147 |
| 2 | $2,903 |
| 3 | $3,660 |
| 4 | $4,417 |
| 5 | $5,173 |
| 6 | $5,930 |
| 7 | $6,687 |
| 8 | $7,443 |
| For each additional person | $757 |

### Low Income Home Energy Assistance Program (LIHEAP) in Maryland Region

In some embodiments, a campaign criteria can include ranges and/or thresholds for a household energy metric, such as energy burden. Energy burden can represent the impact a household's energy costs have on the household's finances. An example energy burden metric is a ratio of energy cost for a household (e.g., electricity cost, combined electricity and gas cost, and the like) to household income. Implementations can evaluate energy cost using: a) monitored energy usage (e.g., electricity usage) and a known cost rate for the monitored energy usage relative to the household's location (e.g., electricity rate, gas rate, and the like), such as average state cost rate, county cost rate, and the like; b) predicted energy usage (e.g., gas usage) and a known cost rate for the predicted energy usage relative to the household's location (e.g., electricity rate, gas rate, and the like), such as average state cost rate, county cost rate, and the like; or c) any combination thereof.

Example campaign criteria include energy burden metric ranges or thresholds, such as 5%, 6%, 7%, 8%, or any other suitable range or threshold. Implementations can calculate a cost for monitored energy usage (e.g., electricity usage) using a cost rate for the monitored energy usage and a cost for predicted energy usage (e.g., gas usage) using a cost rate for the predicted energy usage. In some examples, the sum of these two types or energy costs (e.g., monitored electricity and predicted gas) represent a household's energy cost. The household energy burden metric can be calculated as: Sum of energy costs/predicted income. The household's energy burden metric can be compared to the campaign criteria (e.g., threshold and/or range value(s) for the energy burden metric) to determine a subset of households that meet the campaign criteria. In some examples, a household may have a single energy usage (e.g., monitored electricity usage), and this example household's energy burden metric can be calculated as: electricity energy cost/predicted income.

Other suitable campaigns and qualification criteria can be implemented. When the predicted household information for the given household meets the qualification criteria (e.g., the predicted household income is below the threshold income that corresponds to the predicted number of people in the above table, predicted energy burden meets a threshold, and the like), the customer profile can be targeted for the qualifying campaign. For example, the customer can be targeted with electronic marketing (e.g., mobile messages, push messages, application alerts, and the like), telephone marketing (e.g., phone calls), traditional mailings, and other suitable marketing that supports the customer's adoption of the qualifying campaign.

In some embodiments, implementing the campaign can include performing one or more actions to alter energy usage at the qualifying households. For example, the qualifying households can be selected for programs that improve energy infrastructure at the households, such as insulation, appliance efficiency, energy credits/reimbursements, and the like. In some implementations, the programs can include organizational programs (e.g., government sponsored, state sponsored, etc.) that support household infrastructure improvements. For example, some campaign criteria can select for households with energy infrastructure that is below a conventional standard (e.g., households with aging appliances below modern efficiency metrics, aging houses with poor insulation, and the like). In these examples, the one or more actions of the campaign can adjust the energy usage at qualifying households and improve overall energy infrastructure.

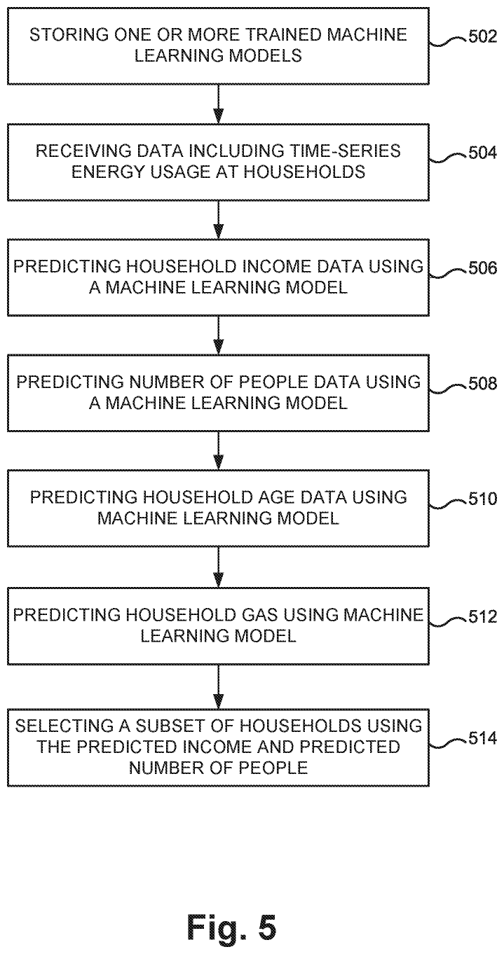

FIG. 5 illustrates a flow diagram for selecting a subset of households using machine learning according to an example embodiment. In some embodiments, the functionality of FIG. 5 can be implemented by software stored in memory or other computer-readable or tangible medium, and executed by a processor. In other embodiments, each functionality may be performed by hardware (e.g., through the use of an application specific integrated circuit (“ASIC”), a programmable gate array (“PGA”), a field programmable gate array (“FPGA”), etc.), or any combination of hardware and software. In embodiments, the functionality of FIG. 5 can be performed by one or more elements of system 200 of FIG. 2.

At 502, one or more trained machine learning models can be stored. For example, one, two, three, or more individual machine learning models can be stored. In some embodiments, individual machine learning models can be configured/trained for a specific prediction task. The machine learning model(s) can be configured to receive, as input, timeseries energy data of a first type (e.g., metered electricity usage) from a household, static features for the household, weather data, any combination of these, or any other suitable input.

In some embodiments, at least a first machine learning model is trained to predict household income using time-series energy usage data of the first type and at least a second machine learning models is trained to predict a number of people per household using time-series energy data of the first type. The first and second machine learning models can comprise components from one or more neural network architectures, such as layers or blocks of a CNN, layers or blocks of an RNN, mixed architecture layers or blocks, and the like. In some embodiments, a third machine learning model is trained to predict an age category for residents of households using time-series energy usage data of the first type. The third machine learning model can comprise components from one or more neural network architectures, such as layers or blocks of a CNN, layers or blocks of an RNN, mixed architecture layers or blocks, and the like. In some embodiments, a fourth machine learning model is trained to predict second type of energy usage for households using time-series energy usage data of the first type. The fourth machine learning model can comprise components from one or more neural network architectures, such as layers or blocks of a CNN, layers or blocks of an RNN, mixed architecture layers or blocks, and the like.

At 504, input data including time-series energy usage data of the first type for a plurality of households can be received. For example, time-series energy usage data of the first type can be metered electricity usage at a plurality of households. The granularity for the time-series energy usage data can include 30 seconds, 1 minute, 5 minutes, 15 minutes, 30 minutes, hourly, daily, weekly, monthly, and the like. In some embodiments, the time-series energy usage data of the first type for the plurality of households can cover a predetermined period of time (e.g., weeks, 1 month, 3 months, 6 months, 1 year, years, and the like).

In some embodiments, static features about the plurality of households can also be received and/or retrieved. The static features can include household real-estate value, census tract income range, demographic information, home features (e.g., square footage, number of bedrooms, number of bathrooms, and the like), and other suitable household static features. In some embodiments, weather data about the weather experienced at the households over the period of time can be received (e.g., temperature/temperature ranges, precipitation, humidity, dew point, pressure, and the like).

At 506, an income per household can be predicted by the first trained machine learning model using the received input data. For example, the first trained machine learning model can predict a household income for each of the plurality of households using the corresponding time-series energy usage data of the first type per household. In some embodiments, the first machine learning model generates the household income prediction using the time-series energy usage data of the first type per household and static features per household. In some embodiments, the first machine learning model generates the household income prediction using the time-series energy usage data of the first type per household, static features per household, and weather data per household.

In some embodiments, the first machine learning model can be trained/configured to predict income over a region (rather than per household) using the time-series energy usage data of the first type, static features, and/or weather data for households across the region. For example, given a geographic region (e.g., census tract, city, county, state, or any other suitable shape for a geographic region), the first machine learning model can predict incomes over the given geographic region (e.g., average income per household, aggregate income across households, and the like).

At 508, a number of people per household can be predicted by a second trained machine learning model using the received input data. For example, the second trained machine learning model can predict a number of people for each of the plurality of households using the corresponding time-series energy usage data of the first type per household. In some embodiments, the second machine learning model generates the number of people prediction using the time-series energy usage data of the first type per household and static features per household. In some embodiments, the second machine learning model generates the number of people prediction using the time-series energy usage data of the first type per household, static features per household, and weather data per household.

In some embodiments, the second machine learning model can be trained/configured to predict the number of people over a region (rather than per household) using the time-series energy usage data of the first type, static features, and/or weather data for households across the region. For example, given a geographic region (e.g., census tract, city, county, state, or any other suitable shape for a geographic region), the second machine learning model can predict a number of people over the given geographic region (e.g., average number of people per household, aggregate number of people living in the region, and the like).

At 510, an age criteria per household can be predicted by the third trained machine learning model using the received input data. For example, the third machine learning model can be trained to predict an age category for the people in a household using the time-series energy usage data of the first type for the household. The predicated age category can be a binary value (i.e., 0 or 1), probability (e.g., 0.5, 0.67, 0.8, etc.), or other suitable value that indicates whether a resident of the household is above a threshold age (e.g., 60, 65, 67, 70, and the like).

In some implementations, a plurality of age ranges can be predefined into categories, such as: Category 1, ages 0-10; Category 2, ages 11-20; Category 3, ages 21-30; Category 4, ages 31-40; Category 5, ages 41-50; Category 6, ages 51-60; Category 7, ages 61-70; Category 8, ages 71-80; Category 9, ages 81-90; and Category 10, ages 90 and above. The predicted category can be a probability that one or more people within the household are within the age range that corresponds to the category. For example, the output from the third machine learning model can be an array where each value in the array corresponds to a probability value for a category. In some embodiments, the categories can be limited to two categories, above or below a threshold age.

In some embodiments, the third machine learning model can generate the age category prediction using the time-series energy usage data of the first type per household and static features per household. In some embodiments, the third machine learning model generates the age category prediction using the time-series energy usage data of the first type per household, static features per household, and weather data per household.

In some embodiments, the third machine learning model can be trained/configured to predict the age category for households over a region (rather than per household) using the time-series energy usage data of the first type, static features, and/or weather data for households across the region. For example, over a given geographic region (e.g., census tract, city, county, state, or any other suitable shape for a geographic region), the third machine learning model can predict an age category for people over the given geographic region (e.g., average age category per household, aggregate number of households categorized into a given age category, and the like).

At 512, a second type of energy usage per household can be predicted by a fourth trained machine learning model using the received input data. For example, the fourth machine learning model can be trained to predict the second type of energy usage (e.g., gas usage) using the time-series energy usage data of the first type (e.g., metered electricity usage) for the household. The predicted second type of energy usage can be a prediction for gas usage over a period of time (e.g., the period of time that corresponds to the time-series energy usage data of the first type) at any suitable granularity (e.g., minutes, hourly, daily, weekly, monthly, etc.), such as a granularity that matches the time-series energy usage data of the first type.

In some embodiments, the fourth machine learning model can generate the second type of energy usage prediction using the time-series energy usage data of the first type per household and static features per household. In some embodiments, the fourth machine learning model can generate the second type of energy usage prediction using the time-series energy usage data of the first type per household, static features per household, and weather data per household.

In some embodiments, the fourth machine learning model can be trained/configured to predict the second type of energy usage for households over a region (rather than per household) using the time-series energy usage data of the first type, static features, and/or weather data for households across the region. For example, given a geographic region (e.g., census tract, city, county, state, or any other suitable shape for a geographic region), the fourth machine learning model can predict the second type of energy usage over the given geographic region (e.g., average gas usage per household, aggregate gas usage over the region, and the like).

In some implementations, the first, second, third, and/or fourth machine learning models operate in parallel (rather than in sequence). For example, first, second, third, and/or fourth machine learning models can receive, as input, the first type of energy usage (e.g., metered electricity usage) for the plurality of households and each can generate its individual component prediction (e.g., income prediction, number of people prediction, age category prediction, or second type of energy usage prediction). In some embodiments, the first, second, third, and/or fourth machine learning models can generate their component predictions using the time-series energy usage data of the first type per household, static features per household, and/or weather data per household.

At 514, a subset of the households comprising predicted household information that meets a campaign criteria can be selected. For example, each household can correspond to a utility customer profile and customer profiles can be targeted using one or more of the predicted income, predicted number of people data, predicated age criteria, and/or predicted second type of energy usage.

In some embodiments, the predicted household income, predicted number of people per household, predicated age criteria, and/or predicted second type of energy usage can be compared to a qualification criteria for an energy campaign. Example energy campaigns include the Low Income Home Energy Assistance Program (LIHEAP), the Weatherization Assistance Program (WAP), and other suitable campaigns. An energy campaign can include a qualification criteria, such as a maximum household income that is variable according to the number of people that reside in the household and/or the age criteria of the people that reside in the household.

In some embodiments, when the predicted number of people and predicted household income for a given customer profile meets the qualification criteria, it is an indication that the customer profile may qualify for the campaign and can benefit from enrolling. In some embodiments, the customer profile can be targeted with electronic marketing (e.g., mobile messages, push messages, application alerts, and the like), telephone marketing (e.g., phone calls), traditional mailings, and other suitable marketing that supports the customer's adoption of the qualifying campaign.

In some embodiments, implementing the campaign can include performing one or more actions to alter energy usage at the qualifying households. For example, the qualifying households can be selected for programs that improve energy infrastructure at the households, such as insulation, appliance efficiency, energy credits/reimbursements, and the like. Example programs can include organizational programs (e.g., government sponsored, state sponsored, etc.) that support household infrastructure improvements. For example, some campaign criteria can select for households with energy infrastructure that is below a conventional standard (e.g., households with aging appliances below modern efficiency metrics, aging households with poor insulation, and the like). In these examples, the one or more actions of the campaign can adjust the energy usage at qualifying households and improve overall energy infrastructure.

In some embodiments, customer profiles can be targeted using the predicted income, predicted number of people data, and predicted age category for the people at a household. For example, some campaigns can include different qualification criteria when a resident of a home meets an age category. The predicted household income, predicted number of people per household, and predicted age category can be compared to the qualification criteria for one or more energy campaigns, and customer profiles that correspond to households with predictions that meet the qualification criteria can be targeted.

In some embodiments, a campaign criteria can include ranges and/or thresholds for a household energy metric, such as energy burden. An example energy burden metric is a ratio of energy cost for a household (e.g., electricity cost, combined electricity and gas cost, and the like) to household income. Implementations can determine energy cost using: a) the first type of energy usage per household (e.g., metered electricity usage) and a known cost rate for the energy usage relative to the household's location (e.g., electricity rate), such as average state cost rate, county cost rate, and the like; b) predicted energy usage of the second type (e.g., gas usage) and a known cost rate for the second type of energy usage relative to the household's location (e.g., gas rate), such as average state cost rate, county cost rate, and the like; or c) any combination thereof.

Example campaign criteria include energy burden metric ranges or thresholds, such as 5%, 6%, 7%, 8%, or any other suitable range or threshold. In an example, a household energy burden metric can be calculated as: Sum of energy costs/predicted income. The household's energy burden metric can be compared to the campaign criteria (e.g., threshold and/or range value(s) for the energy burden metric) to determine a subset of households that meet the campaign criteria. In some examples, a household may have a single energy usage (e.g., monitored electricity usage), and this example household's energy burden metric can be calculated as: electricity energy cost/predicted income.

Embodiments relate to machine learning model(s) trained to process energy usage data and generate household predictions. Machine learning model(s) can be trained to predict household data values for energy usage profiles, and these household data values can then be used to target a subset of the energy usage profiles. For example, a customer energy usage profile can be associated with a household (at which energy is consumed). In some embodiments, at least one machine learning model can be configured (e.g., trained) to predict a household income using time-series household energy usage data (e.g., metered electricity usage). In another example, at least one machine learning model can be configured to predict a number of people at a household using time-series household energy usage data. In another example, at least one machine learning model can be configured to predict an age category for people at a household using time-series household energy usage data. For example, two categories can be predefined, where the detection of a household member that is an age above a threshold (e.g., 60, 65, 68, 70, and the like) places a household in a first of the two categories, and the lack of such a household member places the household in a second of the two categories.

In another example, at least one machine learning model can be configured to predict, using time-series household energy usage data of a first type (e.g., electricity energy usage), a second type of energy usage for the household (e.g., gas energy usage). Implementations of these machine learning models can use time-series energy usage data (e.g., electricity usage) at any suitable granularity (e.g., second(s), hour(s), day(s), week(s), month(s), and the like), weather information, one or more static pieces of household information (e.g., household real-estate value, census tract income range, demographic information, home features, and the like), and any other suitable information.

In some embodiments, the one or more machine learning models can be configured to predict income, number of people, age categories, and/or second type of energy usage (e.g., gas usage) over a region (rather than per household) using time-series energy usage data of the first type for households across the region. For example, given a geographic region (e.g., census tract, city, county, state, or any other suitable shape for a geographic region), the machine learning model(s) can predict incomes over the geographic region (e.g., average income per household, aggregate income across households, and the like), number of people over the geographic region (e.g., average number of people per household, aggregate number of people living in the region, and the like), age categories for people that reside within the geographic region (e.g., average or aggregate number of people within predefined age ranges), and/or second type of energy usage of the geographic region (e.g., average gas usage per household, aggregate gas usage per household, etc.).

Embodiments train machine learning model(s) using instances of time-series energy usage data of the first type (e.g., metered electricity usage) and labels (e.g., household income labels, number of people labels, age for number of people criteria, gas usage labels, and the like). For example, a machine learning model can be designed/selected, such as a neural network. Energy usage data of the first type from multiple source locations (e.g., households) can be obtained, where the energy usage data of the first type can be labeled with income values, number of people in the household values, household resident age values, energy usage values of the second type (e.g., gas usage labels), and/or other suitable label data. In some embodiments, this household energy usage data and label data can be processed to generate training data for the machine learning model(s).

Some embodiments implement an architecture on a deep learning framework. Implementations of the architecture are also extensible and can be tailored with respect to the size of the input and output. The functionality of the deep learning framework, such as initialization of the layers, the implemented optimizer, regularization of values, dropout, and the like can be utilized, removed, or adjusted.

Some embodiments include a convolutional neural network (CNN). In practice, many applications of CNNs are designed to recognize visual patterns (e.g., directly from images for classification). On the other hand, embodiments use a CNN architecture for predicting household information using time-series household energy usage data of the first type (e.g., metered electricity usage). For example, the CNN can be designed to have a number of convolutional layers with various kernel sizes and shapes. This design can be used to learn trends and other aspects of the metered energy usage data. In some embodiments, the deep learning framework includes multiple architectures, such as a recurrent neural network (RNN), convolutional neural network (CNN), one or more blocks of known neural networks (e.g., LeNet, AlexNet, ZFNet, GoogleNet/Inception, VGGNet, ResNet, etc.). Any other suitable neural network architecture or machine learning architecture can be implemented.

In some embodiments, the machine learning model(s) can be configured to generate income prediction(s), number of people prediction(s), age category prediction(s), and/or second type of energy usage prediction(s) using time-series energy usage data of the first type for a plurality of households over a defined period of time, such as weeks, a month, multiple months, a quarter, a year, multiple years, and the like. For example, the time-series data input to generate the prediction(s) can be processed such that it covers the defined period of time. Other input data (e.g., weather data) can be similarly processed to cover the period of time. In some implementations, the period of time can be adjusted, for example during training, testing, retraining, and/or tuning, to achieve a desired performance for the machine learning model(s).

Some embodiments utilize multiple trained learning models, such as an ensemble approach that combines outputs from multiple trained models. Embodiments that implement the ensemble approach can train or configure individual machine learning models for specific prediction tasks, such as predicting household income, predicting a number of people for a household, predicting an age category for people at the household, and/or predicting second type of energy usage values for the household.

In some implementations, the multiple trained models of the ensemble approach operate in parallel (rather than in sequence). For example, two, three, or more individual machine learning models can receive, as input, the first type of energy usage (e.g., metered electricity usage) for a given household along with other suitable features for the given household and each can generate an individual component prediction (e.g., income prediction, number of people prediction, age category prediction, or second type of energy usage prediction). In some implementations, the other features for the given household received by each individual model can comprise similar features, different features, or any other suitable set of other household features. For example, each individual model can receive a set of other household features, where some features are shared among the sets and some features are only provided to one or more of the individual models. One or more of the model predictions can be used to select a subset of households/customer profiles that meet a campaign qualification.

In some implementations, the campaign qualification can relate to one or more campaigns that reduce the energy burden on qualifying households. The qualification for such campaigns can include meeting income criteria based on a number of people at a given household. In some examples, the age of the people at a given household can also impact qualification for a campaign. Different campaigns can reduce energy burden in different ways, such as through cost saving incentives, supporting device upgrades (e.g., credits for upgrading heating and cooling systems, household appliances, household insulation, and other devices), providing credits for low-income households, credits for insulation repairs/upgrades, and the like. Implementations of these campaigns can improve the overall performance of an energy grid, such as by achieving improved efficiencies for energy consuming devices that consume energy from the power grid, increasing the efficiency of heating or cooling a household via improved insulation, or through other suitable improvements.

The features, structures, or characteristics of the disclosure described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present disclosure. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the embodiments as discussed above may be practiced with steps in a different order, and/or with elements in configurations that are different than those which are disclosed. Therefore, although this disclosure considers the outlined embodiments, it would be apparent to those of skill in the art that certain modifications, variations, and alternative constructions would be apparent, while remaining within the spirit and scope of this disclosure. In order to determine the metes and bounds of the disclosure, therefore, reference should be made to the appended claims.

We claim:

1. A method for selecting households using machine learning predictions, the method comprising:
storing one or more trained machine learning models, wherein at least one machine learning model is trained to predict household income using time-series energy usage data;
receiving input data comprising time-series energy usage data for a plurality of households;
predicting, using the trained machine learning models, household income per household; and
selecting a subset of the households comprising a predicted household income that meets one or more campaign criteria, wherein the selected subset of the households are targeted by an energy campaign that corresponds to the campaign criteria, the energy campaign comprising one or more actions to alter energy usage for the targeted households.

2. The method of claim 1, wherein the at least one machine learning model is trained by training data comprising time-series energy usage data and labeled household income values.

3. The method of claim 1, wherein the time-series energy usage data comprises electricity usage at a granularity comprising 30 seconds, 1 minutes, 5 minutes, 15 minutes, 30 minutes, one or more hours, one or more weeks, or one or more months.

4. The method of claim 1, wherein one or more income buckets are predefined, and the predicted household income comprises a predicted income bucket.

5. The method of claim 1, wherein the input data comprises the time-series energy usage data and static household data.

6. The method of claim 5, wherein, for a given's households input data, the static household data comprises one or more of a real-estate home value for the given household or an average income level for a census tract within which the given household is located.

7. The method of claim 1, wherein a second one of the machine learning models is trained to predict a number of people within households using time-series energy usage data, wherein the second machine learning model is trained by training data comprising time-series energy usage data and labeled number of people values.

8. The method of claim 7, further comprising:
predicting, using the second trained machine learning model and the input data, a number of people per household, wherein the predicted household income and the predicted number of people per household are compared to the one or more campaign criteria, and the subset of households comprise predicted household income and predicated number of people that meet the one or more campaign criteria.

9. The method of claim 8, wherein a third one of the machine learning models is trained to predict an age category for people within households using time-series energy usage data, wherein the third machine learning model is trained by training data comprising time-series energy usage data and labeled age category values.

10. The method of claim 9, further comprising:
predicting, using the third trained machine learning model and the input data, an age category for people within households, wherein the predicted household income, the predicted number of people per household, and the predicted age category for people per household are compared to the one or more campaign criteria, and the subset of households comprise predicted household income, predicated number of people, and predicted age categories that meet the one or more campaign criteria.

11. The method of claim 1, wherein the time-series energy usage data used to train the at least one machine learning model and the time-series energy usage data for the plurality of households of the input data comprise electricity usage data.

12. The method of claim 11, wherein a fourth of the machine learning models is trained to predict gas usage for households using the time-series electricity usage data, wherein the fourth machine learning model is trained by training data comprising time-series electricity usage data and labeled gas usage values.

13. The method of claim 12, further comprising:
predicting, using the fourth trained machine learning model and the input data, gas usage per household, wherein the predicted household income, the predicted gas usage per household, and the electricity usage per household are compared to the one or more campaign criteria, and the subset of households comprise predicted household income, predicated gas usage, and electricity usage that meet the one or more campaign criteria.

14. The method of claim 1, wherein the at least one machine learning model comprises one or more components of a convolutional neural network architecture.

15. The method of claim 14, wherein the at least one machine learning model comprises squeeze and excitation blocks.

16. A non-transitory computer readable medium having instructions stored thereon that, when executed by a processor, cause the processor to select households using machine learning predictions, wherein, when executed, the instructions cause the processor to:
store one or more trained machine learning models, wherein at least one machine learning model is trained to predict household income using time-series energy usage data;
receive input data comprising time-series energy usage data for a plurality of households;
predict, using the trained machine learning models, household income per household; and
select a subset of the households comprising a predicted household income that meets one or more campaign criteria, wherein the selected subset of the households are targeted by an energy campaign that corresponds to the campaign criteria, the energy campaign comprising one or more actions to alter energy usage for the targeted households.

17. The computer readable medium of claim 16, wherein the at least one machine learning model is trained by training data comprising time-series energy usage data and labeled household income values.

18. The computer readable medium of claim 16, wherein the time-series energy usage data comprises electricity usage at a granularity comprising 30 seconds, 1 minutes, 5 minutes, 15 minutes, 30 minutes, one or more hours, one or more weeks, or one or more months.

19. The computer readable medium of claim 16, wherein one or more income buckets are predefined, and the predicted household income comprises a predicted income bucket.

20. A system for selecting households using machine learning predictions, the system comprising:
a processor; and
a memory storing instructions for execution by the processor, the instructions configuring the processor to:
store one or more trained machine learning models, wherein at least one machine learning model is trained to predict household income using time-series energy usage data;
receive input data comprising time-series energy usage data for a plurality of households;
predict, using the trained machine learning models, household income per household; and
select a subset of the households comprising a predicted household income that meets one or more campaign criteria, wherein the selected subset of the households are targeted by an energy campaign that corresponds to the campaign criteria, the energy campaign comprising one or more actions to alter energy usage for the targeted households.
